(19) United States
(12) Patent Application Publication
(10) Pub. No.: US 2009/0071354 A1
(43) Pub. Date: Mar. 19, 2009

(54) Quick Stop Controlling Mechanism in Surface Treatment Device of Printing Press

(76) Inventors: Toshio Yamashita, Kanazawa-shi (JP); Takahiko Nakamura, Fuchu-shi (JP)

Correspondence Address: TIPS GROUP;c/o Intellevate LLC, P. O. BOX 52050, Minneapolis, MN, 52050, US

(21) Appl. No.: 12/233,497

(22) Filed: Sep. 18, 2008

(30) Foreign Application Priority Data
Sep. 19, 2007 (JP) 2007-241667

(51) Int. Cl. B41F 7/02

(52) U.S. Cl. 101/218

(57) ABSTRACT

There is provided a surface treatment device of a printing press that does not cause adverse affect on a transfer film in the surface treatment device at a quick stop of the printing press. The transfer film is wound around a plurality of rollers in the surface treatment device, and rollers disposed close to an impression cylinder out of the plurality of rollers are adapted to be capable of being individually driven through motors, respectively. At an emergency stop of the printing press, a controlling section fine-adjusts the running speed of the transfer film into synchronization with the speed of the impression cylinder, by driving the rollers individually while acquiring information from an impression cylinder encoder.

### CROSS REFERENCE TO RELATED APPLICATION

This application claims priority from Japanese Patent Application No. 2007-241667, which is incorporated herein by reference.

### BACKGROUND OF THE INVENTION

1. Field of the Invention

The present invention relates to a surface treatment device of a printing press, which device presses a transfer film onto printed sheets of paper to transfer thereon gold foil, embossed patterns, hologram patterns, and the like, thereby to increase added value of the printed surfaces.

2. Description of the Related Art

A printing press including a surface treatment device for providing added value to printed sheets of paper has been proposed previously. The surface treatment device includes a varnishing unit that applies an ultraviolet curable resin varnish (also simply referred to as “a varnish”) onto the printed sheets of paper printed in a printing unit and a hologram forming unit that presses a transfer film onto the printed sheets varnished in the varnishing unit to perform transfer printing thereon. The hologram forming unit includes an impression cylinder that conveys printed sheets of paper, a pair of pressing rollers that press the transfer film onto the printed sheets on the impression cylinder, and an ultraviolet irradiating unit that cures the varnish while the pressing rollers are pressing the transfer film onto a printed sheet. The pair of pressing rollers are brought apart from and close to the impression cylinder between a retracting position above the impression cylinder and a pressing position proximate to the impression cylinder (e.g., see Japanese Unexamined Patent Publication No. 2006-315229).

In this kind of printing press, since printed sheets are conveyed while being held between the transfer film and the impression cylinder, the running speed of the transfer film and the rotation speed of the impression cylinder need to be synchronized. If these speeds are not synchronized, the transfer film may be creased or may be torn, and even the quality of the printed sheets may be adversely affected. On the other hand, the printing press is configured to make a quick stop when it is jammed or its safety cover is opened. If the printing press makes a stop, the impression cylinder also makes a quick stop, in which case the transfer film may be creased or torn unless the film is quickly stopped at the synchronous timing. The transfer film is however wound around a plurality of rollers, and thus it is difficult to synchronize the running speed of the transfer film with the rotation speed of the impression cylinder at the time of quick stop.

### SUMMARY OF THE INVENTION

In view of the foregoing circumstances, it is an object of the present invention to provide a surface treatment device of a printing press, capable of preventing a tear and the like of a transfer film caused by a quick stop of the printing press and of providing efficient performance with fewer problems by an arrangement, in which at least one of a plurality of rollers around which the transfer film is wound is adapted to be capable of being individually driven, thereby configuring a transfer film driving mechanism capable of establishing synchronization with the actual driving speed of the printing press.

According to the present invention, there is provided a surface treatment device of a printing press, the device including: a cylinder that conveys a sheet; a pressing section that presses a transfer film onto the sheet on the cylinder; a plurality of rollers around which the transfer film is wound; a transfer film driving part that drives running of the transfer film; a controlling section that controls drive of the transfer film driving part; an output part that outputs a signal representative of the rotation speed of the cylinder or the like; and a roller driving part that renders at least one of the plurality of rollers capable of being driven individually, wherein the controlling section controls the drive of the transfer film driving part and the roller driving part based on the signal from the output part at a quick stop of the printing press, to establish synchronization of the rotation speed of the cylinder with the running speed of the transfer film.

The surface treatment device of a printing press according to the present invention is configured such that the controlling section controls the drive of the transfer film driving part and the roller driving part at a quick stop of the printing press, based on the signal outputted from the output part, so as to bring the transfer film to a quick stop while making the running speed of the transfer film into synchronization with the rotation speed of the cylinder; therefore, the transfer film can be protected from, e.g., a tear caused by the quick stop of the printing press, thereby enabling efficient operation with fewer problems.

### BRIEF DESCRIPTION OF THE DRAWINGS

The above, and other objects, features and advantages of the present invention will become apparent from the detailed description thereof in conjunction with the accompanying drawings wherein.

FIG. 1 is a schematic side view of a sheet-fed offset printing press including a surface treatment device according to an embodiment of the present invention;

FIG. 2 is an enlarged side view showing main part of the surface treatment device; and

FIG. 3 is a schematic block diagram showing a controller of the surface treatment device.

### DESCRIPTION OF THE PREFERRED EMBODIMENTS

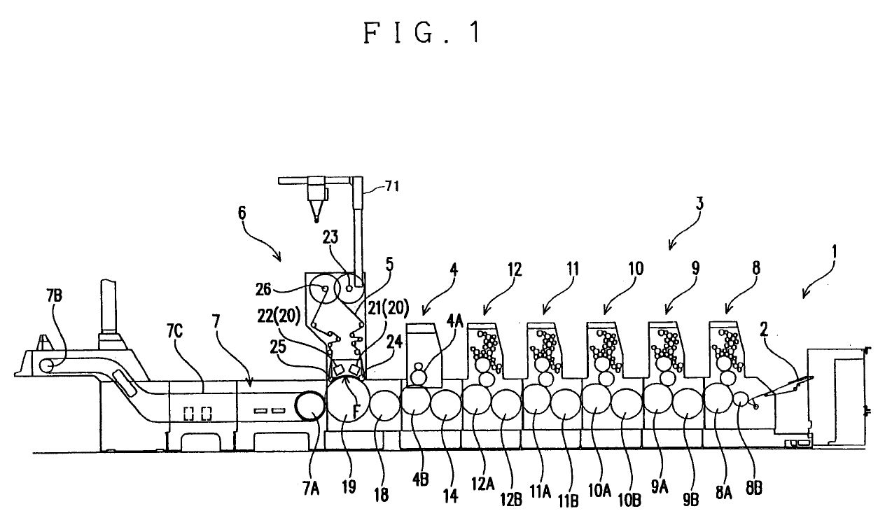

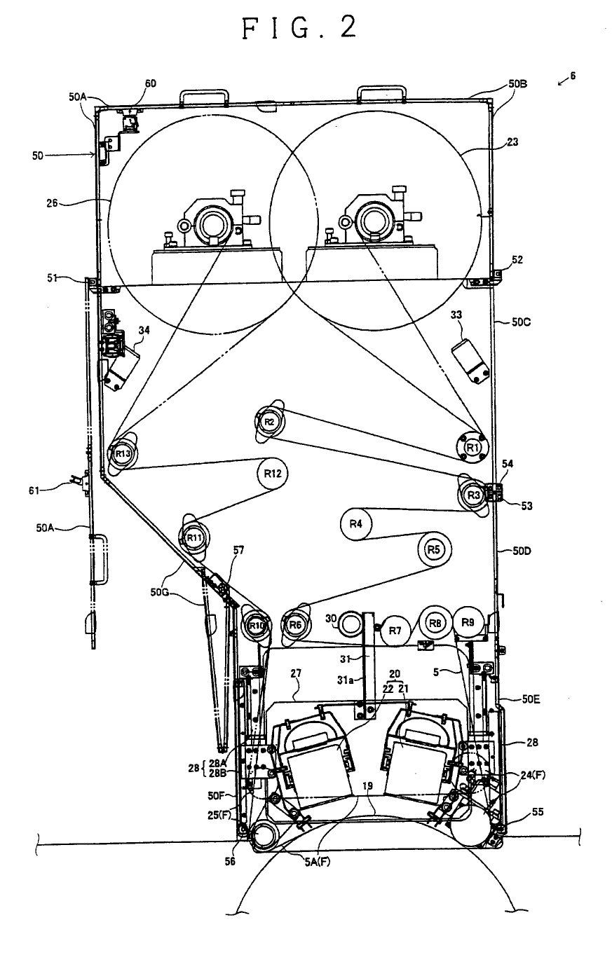

A printing press according to an embodiment of the present invention is described with reference to FIGS. 1 and 2. As shown in the schematic general view of FIG. 1, the printing press according to the present embodiment is a sheet-fed offset printing press. The printing press incorporates a surface treatment device 6 for treating the printed surfaces of printed sheets of paper by varnishing and gloss-finishing the printed surfaces with a resin varnish and transferring thereon gold foil, embossed patterns, hologram patterns, and the like. The printing press includes a sheet feeder section 1, a printer section 3, a varnish applicator section 4, the surface treatment device 6, and a sheet discharge section 7. The sheet feeder section 1 feeds sheets of paper 2 to be printed one by one by means of a feeder device, a sheet separator device, and the like from a sheet stack table. The printer section 3 performs printing on the sheets 2 fed from the sheet feeder section 1. The varnish applicator section 4 applies (coats) an ultraviolet curable resin varnish (also simply referred to as “a varnish”) onto the sheets 2 that have been printed in the printer section 3. The surface treatment device 6 presses a transfer film 5 onto the ultraviolet curable resin varnish over the sheets 2 that have been applied with the ultraviolet curable resin varnish at the varnish applicator section 4, thereby treating the surfaces of the sheets 2. The sheet discharge section 7 discharges the sheets 2 whose surfaces have been treated by the surface treatment device 6. The printing press includes five printing units 8, 9, 10, 11, and 12 as the printer section 3 so that five-color printing can be performed; however, the printer section may be adapted to perform printing in other colors than five colors, such as a single color or more than one colors. The sheet discharge section 7 is a chain conveyor device with grippers. The printing press may however not include the sheet discharge section 7. Also, the specific structure of each section constituting the printing press is not limited to that shown in the figure. Further, while sheets of paper are used as the sheets to be printed, the sheet to be printed may be a continuous elongate sheet.

The printing units 8 to 12 include printing impression cylinders 8A to 12A and delivery cylinders 8B to 12B, respectively. Although not shown in the figure, each of the cylinders 8A to 12A and 8B to 12B is provided with grippers, each having a jaw block and a gripping jaw to grip a fed sheet 2, at two positions (one gripper may also be provided at a single position or more than two grippers may also be provided at more than two positions) in a circumferential direction. The varnish applicator section 4 includes a varnishing cylinder 4A from which the ultraviolet curable resin varnish is supplied and an impression cylinder 4B that is disposed opposite to the varnishing cylinder 4A and coats the ultraviolet curable resin varnish over the printed sheets 2, as well as a delivery cylinder 14 for delivering the sheets 2 to the cylinders 4A and 4B. Each of these cylinders 14 and 4B is also provided with grippers, each having a jaw block and a gripping jaw to grip a fed sheet 2, at two positions (one gripper may also be provided at a single position or more than two grippers may also be provided at more than two positions) in the circumferential direction, as with the above cylinders.

As shown in FIGS. 1 and 2, likewise the varnish applicator section 4, the surface treatment device 6 includes a delivery cylinder 18 on the upstream side and an impression cylinder (may be simply referred to as “a cylinder”) 19 on the downstream side, where the delivery cylinder 18 is provided, at two positions (may be at single position or more than two positions) in the circumferential direction thereof, with grippers for gripping sheets 2 delivered from the impression cylinder 4B, and the impression cylinder 19 receives the sheets 2 from the deliver cylinder 18. The surface treatment device 6 further includes a film pressing section F and an ultraviolet irradiating section 20. The film pressing section F presses the transfer film 5 onto the sheets 2 on the impression cylinder 19. The ultraviolet irradiating section 20 cures the ultraviolet curable resin varnish over the sheets 2 that are being pressed with the transfer film 5 by means of the film pressing section F. The transfer film 5 is pressed onto the sheets 2 on the impression cylinder 19 by the film pressing section F while the transfer film 5 is being fed toward the impression cylinder 19, whereby embossed patterns, hologram patterns, and the like are impressed in the ultraviolet curable resin varnish over the sheets 2, and the transfer film 5 is bonded to the sheets 2 with the varnish acting as an adhesive agent; ultraviolet rays are transmitted through the bonded transfer film 5 to cure the ultraviolet curable resin varnish, so that the transfer film 5 is integrated with the sheets 2. The sheets 2 and the transfer film 5 integrated with each other are moved to the terminal end in the conveying direction, and then the transfer film 5 and the sheets 2 are moved in mutually different directions to be separated from each other, thereby peeling the transfer film 5 from the sheets 2. The transfer film 5 is taken up onto a windup roll 26 to be described later, and the sheets 2 are delivered to the sheet discharge section 7 with the cured ultraviolet curable resin varnish integrated with the sheets 2. Pressing the transfer film 5 onto the ultraviolet curable resin varnish coated over the sheets 2 advantageously allows the surfaces coated with the ultraviolet curable resin varnish to be smoothened and made even glossier. In order to irradiate the ultraviolet curable resin varnish held between the transfer film 5 and the sheets 2 with ultraviolet rays from the ultraviolet irradiating section 20 disposed above the transfer film 5 that is being pressed onto the sheets 2 on the impression cylinder 19, an ultraviolet-transmitting material, e.g., a transparent synthetic resin film, is used for the transfer film 5. The transfer film 5 wound into a roll is set at a predetermined position by a hoist 71 (the hoist 71 is not shown in FIG. 2).

As shown in FIG. 2, the ultraviolet irradiating section 20 includes two (may be one or more than two) ultraviolet lamps and cases 21 and 22 in which the ultraviolet lamps are contained. As shown in FIG. 2, the film pressing section F and the ultraviolet irradiating section 20 are movably configured so as to separate from or approach the impression cylinder 19. While the film pressing section F is at the proximate position (shown with a solid line in the figure) to the impression cylinder 19, the ultraviolet irradiating section 20 is located at the proximate position (shown with a solid line in the figure) to the impression cylinder 19, whereas while the film pressing section F is at the remote position (shown with a chain double-dashed line in the figure) from the impression cylinder 19, the ultraviolet irradiating section 20 is located at the remote position (not shown) from the impression cylinder 19.

As shown in FIGS. 1 and 2, the surface treatment device 6 includes a feed roll 23, two (may be one or more than two) pressing rollers 24 and 25, and the windup roll 26. The feed roll 23 is capable of being wound with the transfer film 5 as well as feeding the transfer film 5. The pressing rollers 24 and 25 press the transfer film 5 fed from the feed roll 23, onto the printed sheets 2 on the impression cylinder 19. The transfer film 5 that has been pressed by the pressing rollers 24 and 25 is peeled off from the sheets 2 and wound up onto the windup roll 26. The film pressing section F is comprised of the pressing rollers 24 and 25 and a portion 5A of the transfer film 5, which portion 5A is being pressed onto a sheet 2 on the impression cylinder 19 by the pressing rollers 24 and 25. As shown in FIG. 2, film guiding rollers R1 to R9 are disposed between the feed roll 23 and the pressing roller 24 on the upstream side in the conveying direction. Film guiding rollers R10 to R13 are disposed between the pressing roller 25 on the downstream side in the conveying direction and the windup roll 26.

The surface treatment device 6 includes one driving part and an interlocking mechanism. The one driving part causes the film pressing section F or the ultraviolet irradiating section 20 to separate from or approach the impression cylinder 19. The interlocking mechanism interlocks the film pressing section F with the ultraviolet irradiating section 20 so that they are integrally moved 8 through the driving part. The interlocking mechanism includes a plate-like support member 27 having a thickness oriented in the horizontal direction, and a pair of guide members 28. The support member 27 supports the pressing rollers 24 and 25 and the transfer film 5 wound between the pressing rollers 24 and 25 that together configure the film pressing section F, as well as the cases 21 and 22 containing the two ultraviolet irradiating lamps (not shown) that together configure the ultraviolet irradiating section 20. The support member 27 is movably configured so as to separate from or approach the impression cylinder 19. The pair of guide members 28 guides the support member 27. The driving part includes an air cylinder (not shown) as an actuator for causing the support member 27 to move. Each of the guide members 28 includes a vertically elongated stationary member 28A with an angular cross section and a movable member 28B. The stationary member 28A is fixed to a casing of the surface treatment device 6. The movable member 28B is mounted to the stationary member 28A with or without a bearing and the like interposed therebetween, so as to be smoothly movable in the vertical direction.

An extension rod of the air cylinder is provided with teeth that engage with a gear 30 that is rotatably supported to the casing of the surface treatment device 6, and the gear 30 is rotated by the elongation and contraction of the extension rod to produce torque, which torque is then converted to vertically moving force by teeth 31a provided on a rack 31; the lower end of the rack 31 is coupled to the upper end of the support member 27 at an approximate center in the sheet-conveying direction. Where the surface treatment is not performed on the sheets 2, the extension rod of the air cylinder is extended, thereby rotating the gear 30 counterclockwise to cause the rack 31 to move to an upward position and to raise the support member 27 to an upward position. In this manner, the film pressing section F (the pressing rollers 24 and 25 as well as the transfer film 5A wound between the pressing rollers 24 and 25) and the ultraviolet irradiating section 20 (the two ultraviolet lamps) are separated (the position of the film pressing section F is only shown in FIG. 2 with the chain double-dashed line) from the impression cylinder 19, and so the surface treatment is not performed on the sheets 2. In order to perform the surface treatment on the sheets 2, the extension rod of the air cylinder is contracted. Then, the film pressing section F (the pressing rollers 24 and 25 as well as the transfer film 5A wound between the pressing rollers 24 and 25) and the ultraviolet irradiating section 20 (the two ultraviolet lamps) are brought close (shown with the solid line in FIG. 2) to the impression cylinder 19, so that the surface treatment can be performed on the sheets 2.

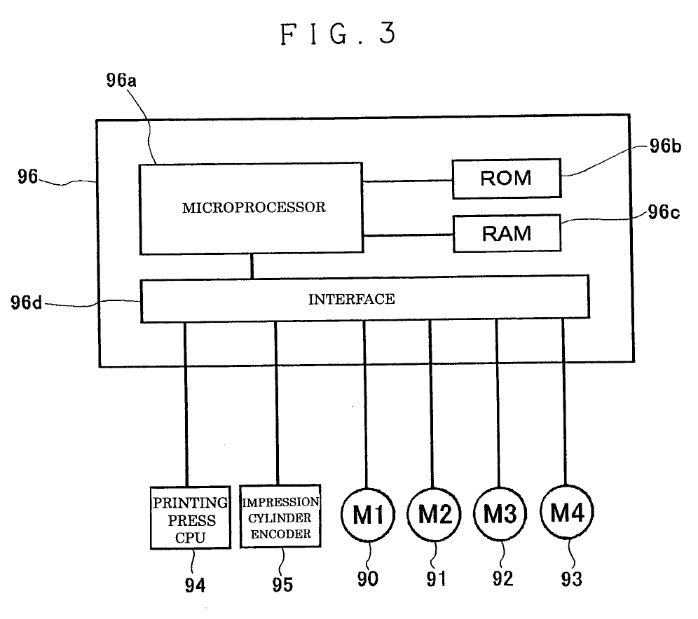

The surface treatment device 6 includes a photosensor 33 to measure the distance up to the transfer film 5 wound on the feed roll 23 and a photosensor 34 to measure the distance up to the transfer film 5 wound up on the windup roll 26. The diameter of the feed roll 23 is monitored based on the distance information from one 33 of the photosensors, and the fed-out length of the transfer film 5 is detected based on the change in the diameter, whilst the diameter of the windup roll 26 is monitored based on the distance information from the other 34 of the photosensors, and the taken-up length of the transfer film 5 is detected based on the change in the diameter. Control signals are outputted from a control device to an electric motor M1 (see FIG. 3) for the feed roll 23 and an electric motor M2 (see FIG. 3) for the windup roll 26 so as to control the feed-out speed of the feed roll 23 and the take-up speed of the windup roll 26 in such a way that the fed-out length detected at the photosensor 33 is matched to the taken-up length detected at the photosensor 34 at all times.

As shown in FIG. 2, the surface treatment device 6 is covered with a cover portion 50. As described above, since many rollers, cylinders, and the like are disposed inside the surface treatment device 6, and besides the transfer film 5 is wound around the rollers through a complex path, the cover portion 50 is desirably fully openable for, e.g., the maintenance purpose. For this reason, the cover portion 50 includes seven divided covers 50A to 50G. Specifically, as shown with chain double-dashed lines in FIG. 2, the cover 50A is configured to be pivotable counterclockwise in FIG. 2 about a hinge 51, and the cover 50G is configured to be pivotable counterclockwise in FIG. 2 about a hinge 57. The other covers 50B to 5OF are also configured to be pivotable about hinges 52 to 56. In this manner, the cover portion 50 is constructed from the divided covers, and the covers are all openable, which provides a structure capable of being handled very easily in maintenance operation and the like.

The casing of the surface treatment device is provided with seven electromagnetic switches 60 (part of which is not shown) corresponding to the covers 50A to 50G, respectively. The covers 50A to 50G are provided with engaging portions 61 that are engageable with the electromagnetic switches 60 respectively. Usually, the covers 50A to 50G are openable (engageable/releasable) with respect to the electromagnetic switches 60. While an engaging portion 61 engages with an electromagnetic switch 60 and a current is being applied through the electromagnetic switch 60, the engaging portion 61 is held unreleasable to the electromagnetic switch 60 by means of an electromagnetic locking mechanism. In addition, a controller (not shown) performs control such that the electromagnetic switches 60 are energized only while the printing press is in operation. Thus, the covers 50A to 50G are reliably kept closed by means of the electromagnetic lock during the operation of the printing press, thus preventing to the least possible extent problems, such as the transfer film 5 in the surface treatment device 6 being creased, caused by the quick stop of the printing press at an accidental opening of any of the covers 50A to 50G during the operation of the printing press, and enabling efficient and safe operation. The controller controls the printing press such that the printing press does not initiate operation unless the engaging portions 61 are all engaged with the electromagnetic switches 60, i.e., the covers 50A to 50G are all closed.

When a jam occurs during operation of the printing press, or when any of the covers of the printing units 8 to 12 is opened, the controller causes the printing press to make a quick stop. In such a case, the electromagnetic switches 60 are continuously energized until the operation of the printing press comes to a full stop. Accordingly, the covers 50A to 50G will not open easily at quick stops, with the result of improved safety.

FIG. 3 is a schematic block diagram showing the controller of the surface treatment device of the printing press according to an embodiment of the present invention. The controller includes the motor M1 for driving the feed roll 23, the motor M2 for driving the windup roll 26, a motor M3 for driving the roller R5, a motor M4 for driving the roller R9, a printing press CPU 94 that controls the main body of the printing press, an impression cylinder encoder 95 provided on the impression cylinder 19 to output rotation speed signals, angle signals, and the like, and a controlling section 96. The controlling section 96 is configured with, e.g., a microprocessor 96a (may be a sequencer) that executes arithmetic processing and the like, a ROM 96b that stores data and predetermined programs (arithmetic expressions, tables, and the like), a RAM 96c capable of storing various kinds of information relating to the number of mechanical rotations and the like, and an interface 96d that mediates exchange of various signals between the microprocessor 96a and a device outside the controlling section 96.

A description is made below on the quick stop control performed by the controller over the surface treatment device of the printing press according to an embodiment of the present invention. When a jam occurs during printing, or when the printing press is stopped quickly by, e.g., being opened at the cover of any of its printing units 8 to 12, the printing press CPU 94 outputs a quick stop signal to the controlling section 96. Based on the quick stop signal and signals from the impression cylinder encoder 95, the controlling section 96 controls the drive of the transfer film driving parts M1 and M2 and the roller driving parts M3 and M4 so as to bring the transfer film 5 to a quick stop while making the running speed of the transfer film 5 into synchronization with the rotation speed of the impression cylinder 19. It is difficult to completely synchronize the rotation speed of the impression cylinder 19 with the running speed of the transfer film 5 merely through the control over the motor M1 driving the feed roll 23 and the motor M2 driving the windup roll 26. For this reason, the controlling section 96 controls the drive of the motors M3 and M4 so as to individually drive the rollers R5 and R9 on which the transfer film 5 is running in the vicinity of the impression cylinder 19, thereby fine-adjusting the running speed of the transfer film 5 to bring the running speed of the transfer film 5 into synchronization with the rotation speed of the impression cylinder 19. In addition, since the controlling section 96 acquires not only signals from the printing press CPU 94 but also signals from the impression cylinder encoder 95, the controlling section 96 controls the drive of the motors M3 and M4 according to the actual rotation speed (live data) of the impression cylinder 19. Consequently, the running speed of the transfer film 5 can be synchronized with the rotation speed of the impression cylinder 19 substantially perfectly. In actual printing operation, e.g., in which the printing press supplies sheets 2 at a rate of 10000 sheets per hour, when a quick stop instruction is issued, the impression cylinder 19 rotates several times as from the issuance of the quick stop instruction to the halt of the impression cylinder 19. While controlling the drive of the motors M3 and M4 to bring the running speed of the transfer film 5 into synchronization with the rotation speed of the impression cylinder 19 during that period, the controlling section 96 halts the transfer film 5. It should be noted that the electromagnetic switches 60 are continuously energized until the operation of the printing press comes to a full stop; therefore, the covers 50A to 50G are prevented from opening accidentally at the quick stop, which contributes to increased safety.

The mechanism of the surface treatment device in the printing press according to the present invention is not limited to the above-described embodiments, and various changes and modifications can be made within the scope of the claims. For example, although the two rollers R5 and R9 are adapted to be capable of being individually driven in the foregoing embodiments, at least one roller may be adapted to be capable of being individually driven. Further, although the printing press in the foregoing embodiments is a sheet-fed offset printing press, the present invention is not limited thereto and is applicable to a rotary offset printing press or a flexographic printing press.

The surface treatment device of a printing press according to the present invention is highly useful in printing presses provided with surface treatment devices.

This specification is by no means intended to restrict the present invention to the preferred embodiments set forth therein. Various modifications to the quick stop controlling mechanism in a surface treatment device of a printing press, as described herein, may be made by those skilled in the art without departing from the spirit and scope of the present invention as defined in the appended claims.

What is claimed is:

1. A surface treatment device of a printing press, the device comprising:
a cylinder that conveys a sheet;
a pressing section that presses a transfer film onto the sheet on the cylinder;
a plurality of rollers around which the transfer film is wound;
a transfer film driving part that drives running of the transfer film;
a controlling section that controls drive of the transfer film driving part;
an output part that outputs a signal representative of the rotation speed of the cylinder or the like; and
a roller driving part that renders at least one of the plurality of rollers capable of being driven individually, wherein
the controlling section controls the drive of the transfer film driving part and the roller driving part based on the signal from the output part at a stop of the printing press, to establish synchronization of the rotation speed of the cylinder with the running speed of the transfer film.

2. A method of controlling a surface treatment device of a printing press, the method comprising
rotating a cylinder and running a transfer film while pressing the transfer film onto a sheet on the cylinder, wherein
the running speed of the transfer film is synchronized with the rotation speed of the cylinder based on the rotation speed of the cylinder, at a stop of the printing press.
